(19) United States
(12) Patent Application Publication
(10) Pub. No.: US 2023/0342493 A1
(43) Pub. Date: Oct. 26, 2023

(54) INFORMATION PROCESSING APPARATUS, INFORMATION PROCESSING METHOD, AND PROGRAM

(71) Applicant: SONY GROUP CORPORATION, TOKYO (JP)

(72) Inventor: RYO KAMASAKA, TOKYO (JP)

(21) Appl. No.: 18/246,538

(22) PCT Filed: Oct. 8, 2021
(86) PCT No.: PCT/JP2021/037363

§ 371 Date: Mar. 24, 2023

(30) Foreign Application Priority Data
Oct. 13, 2020 (JP) 2020-172336

(51) Int. Cl. G06F 21/62

(52) U.S. Cl. CPC G06F 21/6245; G06F 2221/2141

(57) ABSTRACT

The present invention makes it possible to disclose, to a user, an image generated according to a degree of closeness which indicates the relationship between the user and a contributor.

A disclosure permitting/denying determination section obtains a result of determination as to whether disclosure of each determination target object to a user is permitted or denied, the determination target object being included in an image to be submitted to an image submission server. The determination as to whether the disclosure is permitted or denied is made on the basis of degree-of-closeness information which indicates the relationship between the user and a contributor. For example, the disclosure permitting/denying determination section supplies the determination result to a user interface section so as to allow the contributor to confirm the determination result. In addition, for example, the disclosure permitting/denying determination section corrects the determination result according to a correction command supplied from the user interface section. For example, on the basis of the result of the determination as to whether the disclosure is permitted or denied, a disclosure image to be disclosed to the user is generated by use of the image to be submitted to the image submission server and information regarding the determination target object.

### TECHNICAL FIELD

The present technology relates to an information processing apparatus, an information processing method, and a program, and more specifically, relates to an information processing apparatus, etc., for appropriately protecting privacy of an image that is disclosed to users.

### BACKGROUND ART

There is a possibility that an image (picture) that a contributor uploads to an image submission server such as an SNS (Social Networking Service) server includes personal information. Disclosing the original image is dangerous from the viewpoint of privacy protection. For this reason, SNS has a function of disclosing an image submitted by a contributor, to particular SNS users only. However, this function is an inconvenience because the disclosure is allowed only to SNS users who are closely connected to the contributor on the SNS.

For example, PTL 1 discloses restricting the range of users to whom an image is disclosed, on the basis of the relationship with a contributor. Further, for example, PTL 2 discloses restricting the range of users to whom an image is disclosed, on the basis of information regarding a disclosure request from a contributor and information regarding a disclosure permission from a subject (photographed user).

### CITATION LIST

### Patent Literature

[PTL 1]
Japanese Patent Laid-open No. 2007-235239
[PTL 2]
Japanese Patent Laid-open No. 2016-066121

### SUMMARY

### Technical Problem

An object of the present technology is to allow disclosure of an image generated according to a degree of closeness which indicates the relationship between a user and a contributor, to the user.

### Solution to Problem

A concept of the present technology provides an information processing apparatus including a disclosure permitting/denying determination section that obtains, on the basis of degree-of-closeness information indicating the relationship between a user and a contributor, a result of determination as to whether disclosure of a determination target object to the user is permitted or denied, the determination target object being included in an image to be submitted to an image submission server.

In the present technology, the disclosure permitting/denying determination section obtains the result of the determination as to whether the disclosure of the determination target object, which is included in the image to be submitted to the image submission server, to the user is permitted or denied. Here, whether the disclosure is permitted or denied is determined on the basis of the degree-of-closeness information which indicates the relationship between the user and the contributor.

For example, the relationship between the user and the contributor may be set to a friend on the image submission server. In this case, it is possible to obtain a result of determination as to whether to permit or deny the disclosure to a user who is a friend of the contributor on the image submission server.

In addition, for example, the disclosure permitting/denying determination section may supply the determination result to a user interface section so as to allow the contributor to confirm the determination result. Accordingly, it is possible to allow the contributor to confirm the determination result through the user interface section. In this case, for example, the disclosure permitting/denying determination section may correct the determination result according to a correction command supplied from the user interface section. Accordingly, it is possible to allow the contributor to correct the determination result.

In addition, for example, the determination target object may be an object related to privacy protection. Accordingly, a result of determination as to whether disclosure of the object related to privacy protection is permitted or denied can be obtained. In this case, for example, the determination target object may be a human face. Accordingly, it is possible to obtain a result of determination as to whether disclosure of the human face is permitted or denied. Further, in this case, the disclosure permitting/denying determination section may determine whether the disclosure is permitted or denied, depending on whose face is the determination target object. Accordingly, it is possible to make the determination as to whether the disclosure is permitted or denied, depending on whose face (e.g., the contributor, any one of friends or a stranger on the image submission server) is the determination target object.

In addition, for example, the degree-of-closeness information may indicate the relationship between the user and the contributor that is classified as any one of a close friend, a friend, an estranged friend, an acquaintance, and a stranger. Accordingly, it is possible to obtain the result of the determination as to whether the disclosure to the user is permitted or denied, on the basis of whether the relationship with the contributor is a close friend, a friend, an estranged friend, an acquaintance, or a stranger.

In addition, for example, an object detection section that detects the determination target object included in the image to be submitted to the image submission server may further be included. In this case, it is possible to detect the determination target object included in the image to be submitted to the image submission server, by means of the object detection section. For example, in a case where the determination target object is a human face, the object detection section may further detect whose face has been detected. Accordingly, it is possible to detect whose face has been detected, by means of the object detection section.

In addition, for example, from a user interface section being operated by the contributor, the disclosure permitting/denying determination section may obtain the degree-of-closeness information which indicates the relationship between the user and the contributor. Accordingly, it is possible to obtain the result of the determination as to whether the disclosure to the user is permitted or denied, on the basis of the degree-of-closeness information defined by the contributor to indicate the relationship between the user and the contributor.

In addition, for example, a degree-of-closeness determination section that obtains the degree-of-closeness information which indicates the relationship between the user and the contributor, on the basis of information obtained from the image submission server, may further be included. In this case, it is possible to obtain the degree-of-closeness information which indicates the relationship between the user and the contributor, on the basis of the information obtained from the image submission server, by means of the degree-of-closeness determination section.

In this case, for example, the degree-of-closeness determination section may calculate a degree-of-closeness value of the user on the basis of the information obtained from the image submission server, and obtain the degree-of-closeness information by comparing the calculated degree-of-closeness value with a threshold value. Accordingly, it is possible to appropriately obtain the degree-of-closeness information.

In this case, for example, the information obtained from the image submission server may include at least either an uploaded image or chat information. Here, for example, information added to the uploaded image may include at least either information indicating a time elapsed from capturing of the uploaded image or information regarding whether the uploaded image is a selfie. Accordingly, it is possible to precisely obtain the degree-of-closeness information which indicates the relationship between the user and the contributor.

In addition, for example, an image generation section that generates, on the basis of the result of the determination as to whether the disclosure is permitted or denied, a disclosure image to be disclosed to the user, by use of the image to be submitted to the image submission server and information regarding the determination target object, may further be included. In this case, it is possible to generate the disclosure image to be disclosed to the user, by means of the image generation section, so that a load on the image submission server can be reduced. The disclosure image is used after being uploaded to the image submission server.

In this case, for example, the information regarding the determination target object may include at least positional information regarding an image of a partial region that includes the determination target object in the image to be submitted to the image submission server. Accordingly, it is possible to appropriately generate the disclosure image in response to a determination result indicating prohibition of the disclosure of the determination target object, by eliminating information regarding the determination target object from an image of a partial region that includes the determination target object in an input image.

In this case, for example, the information regarding the determination target object may further include an image of the partial region from which information regarding the determination target object has been eliminated. Accordingly, it is possible to appropriately and easily generate the disclosure image in response to the determination result indicating prohibition of the disclosure of the determination target object, by replacing the image of the partial region that includes the determination target object in an input image, with an image of the partial region from which information regarding the determination target object has been eliminated.

In such a manner, according to the present technology, the result of the determination as to whether the disclosure of the determination target object, which is included in the image to be submitted to the image submission server, to the user is permitted or denied is obtained on the basis of the degree-of-closeness information which indicates the relationship between the user and the contributor. As a result, it is possible to disclose, to the user, an image generated according to the degree of closeness which indicates the relationship with the contributor, and allows the disclosure of the image to many users while protecting privacy in the image to be disclosed to the users. This enhances the convenience.

Further, another concept of the present technology provides an information processing method including a disclosure permitting/denying determination process of obtaining, on the basis of degree-of-closeness information indicating the relationship between a user and a contributor, a result of determination as to whether disclosure of a determination target object to the user is permitted or denied, the determination target object being included in an image to be submitted to an image submission server.

Further, still another concept of the present technology provides a program for causing a computer to function as a disclosure permitting/denying determination section that obtains, on the basis of degree-of-closeness information indicating the relationship between a user and a contributor, a result of determination as to whether disclosure of a determination target object to the user is permitted or denied, the determination target object being included in an image to be submitted to an image submission server.

### BRIEF DESCRIPTION OF DRAWINGS

FIG. 1 is a block diagram depicting a configuration example of an image disclosing system according to an embodiment.

FIG. 2 is a block diagram depicting a configuration example of an information processing apparatus.

FIG. 3 is a diagram of an outline of determination of a degree of closeness in a degree-of-closeness determination section.

FIG. 4 is a block diagram depicting a configuration example of the degree-of-closeness determination section.

FIG. 5 depicts diagrams for explaining the direction of a face and the direction of the line of sight.

FIG. 6 is a diagram for explaining a selfie determination based on a face size ratio γ.

FIG. 7 is a block diagram depicting a configuration example of determination sections of the degree-of-closeness determination section.

FIG. 8 is a block diagram depicting a configuration example of a disclosure permitting/denying determination section.

FIG. 9 is a diagram depicting one example of a determination result confirmation screen which is a user interface screen displayed on a display section of a user interface section.

FIG. 10 is a diagram depicting one example of a determination result correction screen which is a user interface screen to be displayed in a case where a “correction” button is operated.

FIG. 11 is a flowchart depicting one example of processing procedure performed by the information processing apparatus.

FIG. 12 is a diagram depicting one example of an image (disclosure image) that is automatically generated by the information processing apparatus and that is viewed by SNS users (friends and strangers on SNS).

FIG. 13 is a diagram depicting a configuration example of a PC (personal computer) included in the information processing apparatus.

FIG. 14 is a block diagram depicting another configuration example of the information processing apparatus.

FIG. 15 is a block diagram depicting still another configuration example of the information processing apparatus.

### DESCRIPTION OF EMBODIMENT

A mode for carrying out the invention (hereinafter, referred to as an “embodiment”) will be explained below. It is to be noted that the explanation will be given in the following order.
1. Embodiment
2. Modification

### 1. Embodiment

### (Image Disclosing System)

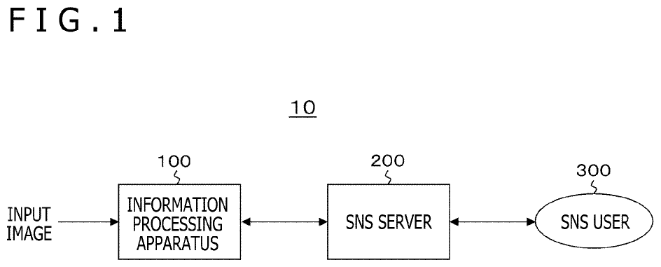

FIG. 1 depicts a configuration example of an image disclosing system 10 according to an embodiment. The image disclosing system 10 includes an information processing apparatus 100 and an SNS server 200.

The information processing apparatus 100 is an application in a personal computer, for example. However, the information processing apparatus 100 may be implemented by any other electronic equipment. That is, the information processing apparatus 100 may be an application in electronic equipment, e.g., a smartphone, a tablet, and a digital camera, provided with a network facility capable of communicating with the SNS server 200.

The information processing apparatus 100 generates, from an input image which is an image to be submitted to the SNS server 200, a disclosure image to be disclosed to an SNS user 300, and uploads the disclosure image to the SNS server 200. In this case, the information processing apparatus 100 detects, in the image to be submitted, a determination target object which is, for example, an object (for example, a human face) related to privacy protection, and obtains a result of the determination as to whether disclosure of the determination target object to the SNS user 300 is permitted or denied, on the basis of information regarding a degree of closeness which indicates the relationship between the SNS user 300 and a contributor. Then, on the basis of the determination result, a disclosure image is generated by using the image to be submitted and information regarding the determination target object.

The SNS server 200 holds the disclosure image uploaded from the information processing apparatus 100. In a case where a request to view a submitted image is received from the SNS user 300, the SNS server 200 sends a disclosure image corresponding to the SNS user 300, that is, a disclosure image corresponding to the degree of closeness which indicates the relationship between the SNS user 300 and the contributor, to the SNS user 300 such that the SNS user 300 can view the disclosure image.

Accordingly, an image that is generated according to the degree of closeness which indicates the relationship with the contributor can be disclosed to the SNS user 300, and disclosure of the image to many SNS users 300 is allowed while privacy is protected in the image to be disclosed to the SNS users 300. This enhances the convenience.

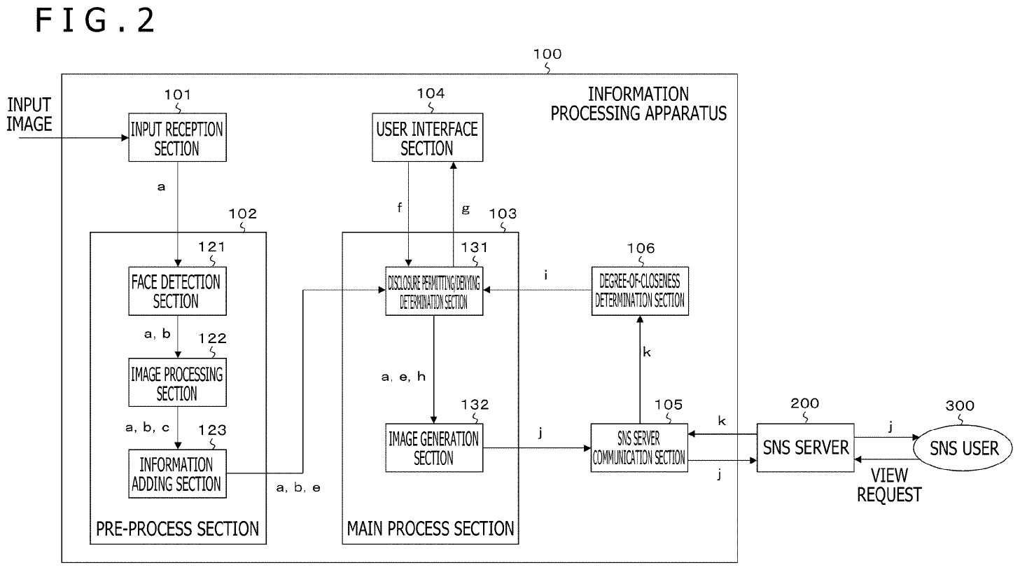

FIG. 2 depicts a configuration example of the information processing apparatus 100. The information processing apparatus 100 includes an input reception section 101, a pre-process section 102, a main process section 103, a user interface section 104, an SNS server communication section 105, and a degree-of-closeness determination section 106.

The input reception section 101 receives an input image which is an image to be submitted to the SNS server 200. The input image may be obtained by an external digital camera. Alternatively, in a case where the information processing apparatus 100 is an application in electronic equipment having a digital camera function, the input image may be obtained by the digital camera function. In another case, the input image may previously be obtained by a camera, held in a storage, and then read out.

The pre-process section 102 includes a face detection section 121, an image processing section 122, and an information adding section 123. The face detection section 121 receives an input image “a” from the input reception section 101. Then, the face detection section 121 detects a human face as an image related to privacy protection. Accordingly, a human face included in the input image “a,” which is an image to be submitted to the SNS server 200, can be detected. Here, the detected face is a determination target object for which a determination is made by a disclosure permitting/denying determination section 131. Specifically, the disclosure permitting/denying determination section 131 determines whether the disclosure of the determination target object to SNS users (the friends and strangers on the SNS) is permitted or denied, which will be described in detail later. Accordingly, it is possible to obtain a result of the determination as to whether the disclosure of an object (e.g., a face) related to privacy protection is permitted or denied, by means of the disclosure permitting/denying determination section 131.

For each of the detected faces, the face detection section 121 performs individual identification to identify whether the face is any one of the friends on the SNS or a stranger who is not an SNS friend, on the basis of friend information (including face image information) which is included in information “k” obtained from the SNS server 200 via the SNS server communication section 105. Accordingly, it is possible to detect whose face has been detected.

The face detection section 121 outputs the input image “a” and a face detection result “b.” Here, for each of the detected faces, the face detection result “b” includes a partial region image including the face, positional information indicating the position of the partial region image in the input image “a,” and individual identification information regarding the face. The face detection result “b” forms information regarding a face which is a determination target object.

The image processing section 122 receives the input image “a” and the face detection result “b” from the face detection section 121. For each of the detected faces, the image processing section 122 generates a face-information-eliminated image “c” that is a partial region image obtained by eliminating face information from the partial region including the face. Here, the face information is eliminated by performing mosaic processing, by filling the face with a predetermined color, or replacing the face with a predetermined character face, for example. The image processing section 122 outputs the input image “a,” the face detection result “b,” and the face-information-eliminated images “c” of the respective detected faces. The face-information-eliminated image “c” also forms the information regarding a face which is a determination target object.

The information adding section 123 receives the input image “a,” the face detection result “b,” and the face-information-eliminated images “c” of the respective detected faces from the image processing section 122. The information adding section 123 tags the face-information-eliminated image “c” of each of the detected faces with positional information, individual identification information, and information indicating that the human face is originally included. The information adding section 123 outputs the input image “a,” the face detection result “b,” and face-information-eliminated images “e” of the respective detected faces that have undergone the information tagging.

The degree-of-closeness determination section 106 calculates a degree-of-closeness value of each SNS friend on the basis of information obtained from the SNS server 200 via the SNS server communication section 105, and obtains the degree of closeness indicating the relationship between the friend and the contributor, by comparing the calculated degree-of-closeness value with a threshold value. Then, the degree-of-closeness determination section 106 outputs degree-of-closeness information “i” regarding SNS users (the friends and strangers on the SNS). Since such a degree-of-closeness determination section 106 is provided, it is possible to obtain the degree-of-closeness information “i” which indicates the relationship between the SNS users and the contributor, on the basis of the information obtained from the SNS server 200. Further, the degree-of-closeness value of each SNS friend is calculated, and the calculated degree-of-closeness value is compared with a threshold value, whereby the degree of closeness indicating the relationship between the friend and the contributor is obtained. Accordingly, the degree-of-closeness information “i” can appropriately be obtained.

The information obtained from the SNS server 200 includes, in addition to the friend information (which includes face image information), an uploaded image, information added to the uploaded image, chat information, and the like. The information added to the uploaded image includes at least either image-captured date information or selfie information. Accordingly, it is possible to precisely obtain the degree-of-closeness information “i” which indicates the relationship between each SNS user and the contributor.

Any information is adopted as the selfie information as long as the information indicates that the uploaded image is a selfie taken with a smartphone, a normal camera, or the like. For example, in a case where an uploaded image is taken with a smartphone equipped with a rear camera and a front camera or a smartphone equipped with a front camera alone, the selfie information regarding the uploaded image may indicate that the image is taken with the front camera. In addition, for example, in a case where an uploaded image is taken with a camera having a rotatable monitor, the selfie information regarding the uploaded image may indicate that the image has been taken with the monitor rotated by 180 degrees. In addition, for example, the selfie information may be set by a user to indicate that the uploaded image is a selfie, when the user takes an image of his or her self by using a smartphone, a normal camera, or the like. It is to be noted that whether the uploaded image is a selfie is determined on the basis of the selfie information in some cases, or is determined on the basis of the contents of the uploaded image in other cases, which will be explained later.

Both an uploaded image and chat information are not necessarily required to obtain the degree-of-closeness information. That is, it is sufficient that the information obtained from the SNS server 200 includes at least either an uploaded image or chat information.

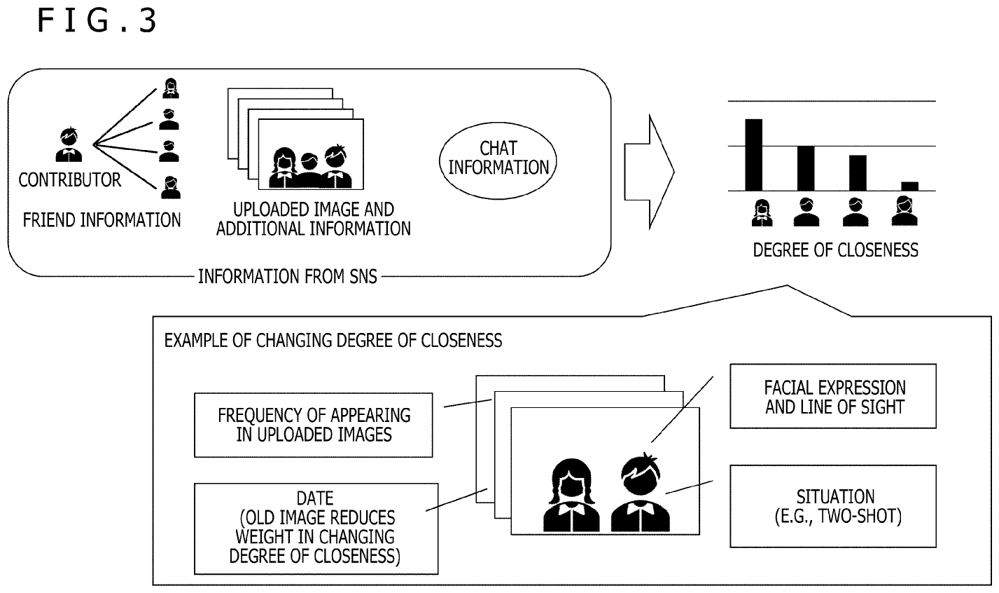

FIG. 3 depicts an outline of determination of the degree of closeness in the degree-of-closeness determination section 106. As depicted in FIG. 3, according to the friend information (which includes the face image information), the degree-of-closeness determination section 106 determines a degree of closeness of each SNS user who is an SNS friend, by using the information “k” obtained from the SNS server 200 via the SNS server communication section 105. The information “k” includes an uploaded image, information added to the uploaded image, chat information, and the like. Accordingly, the disclosure permitting/denying determination section 131, which will be explained later, can obtain a result of the determination as to whether the disclosure to the SNS user who is an SNS friend of the contributor is permitted or denied.

A certain method of changing the degree of closeness regarding an uploaded image uses the frequency at which the SNS user and the contributor appear together in uploaded images, a facial expression and the line of sight of the SNS user appearing together with the contributor in an uploaded image, a situation (e.g., two shot) in an uploaded image in which the SNS user and the contributor appear together, and the date when an uploaded image was captured in which the SNS user and the contributor appear together, for example.

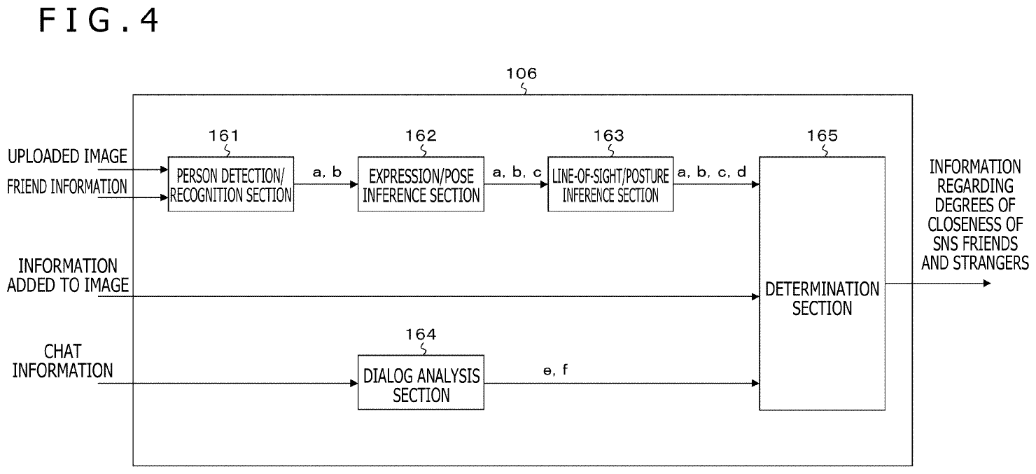

FIG. 4 depicts a configuration example of the degree-of-closeness determination section 106. The degree-of-closeness determination section 106 includes a person detection/recognition section 161, an expression/pose inference section 162, a line-of-sight/posture inference section 163, a dialog analysis section 164, and a determination section 165.

The person detection/recognition section 161 detects a person in each of uploaded images on the basis of the uploaded image and the friend information as well as contributor information (which includes face information), and makes individual identification as to whether each of the detected persons is the contributor, any one of the SNS friends, or a third person, i.e., a stranger. The person detection/recognition section 161 outputs the uploaded images “a” and the person detection results “b” of the respective uploaded images. Each of the person detection results “b” includes the number of detected persons and individual identification information regarding each of the detected persons.

From the person detection/recognition section 161, the expression/pose inference section 162 receives the uploaded images “a” and the person detection results “b” of the respective uploaded images. By conducting an image analysis for each of the uploaded images in which the contributor and SNS friends appear together, the expression/pose inference section 162 infers whether a facial expression or pose of each of the SNS friends is positive. For example, a smile is considered to be a positive expression, and a V-sign is considered to be a positive pose. The expression/pose inference section 162 outputs the uploaded images “a,” the person detection results “b” of the respective uploaded images, and expression/pose inference information “c” regarding each of the SNS friends appearing together with the contributor in the uploaded images.

From the expression/pose inference section 162, the line-of-sight/posture inference section 163 receives the uploaded images “a,” the person detection results “b” of the respective uploaded images, and the expression/pose inference information “c” regarding each of the SNS friends appearing together with the contributor in the uploaded images. By conducting an image analysis for each of the uploaded images in which the contributor and SNS friends appear together, the line-of-sight/posture inference section 163 infers the line of sight or posture of each of the SNS friends. Specifically, the line-of-sight/posture inference section 163 infers whether the line of sight of the SNS friend is pointing toward the camera, and which direction the face of the SNS friend is facing with respect to the camera.

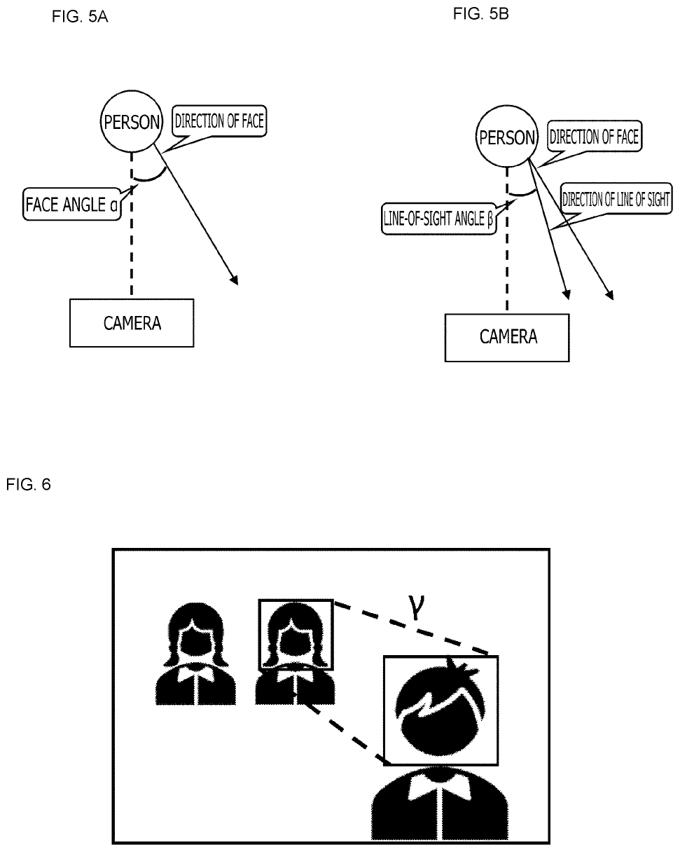

In this case, it is assumed that an angle of the face with respect to the camera is defined as a face angle α as depicted in (a) of FIG. 5. In a case of −45°<α<45°, it is determined that the face is facing the camera. In a case of 45°≤α≤90°, it is determined that the face is facing a direction to the right of the camera. In a case of −90°≤α≤−45°, it is determined that the face is facing a direction to the left of the camera. In a case where the face angle α does not fall within any of the above ranges, it is determined that the face is facing opposite the camera. Further, in this case, it is assumed that an angle of the line of sight with respect to the camera is defined as a line-of-sight angle β as depicted in (b) of FIG. 5. In a case of −45°<α<45°, the line of sight is determined to point toward the camera. It is to be noted that FIG. 5 depicts the example in which the direction of the face is different from the direction of the line of sight. However, needless to say, these directions can be identical to each other in some cases.

Referring back to FIG. 4, the line-of-sight/posture inference section 163 outputs the uploaded images “a,” the person detection results “b” of the respective uploaded images, the expression/pose inference information “c” regarding each of the SNS friends appearing together with the contributor in the respective uploaded images, and expression/pose inference information “d” regarding each of the SNS friends appearing together with the contributor in the respective uploaded images.

The dialog analysis section 164 analyzes the subject of a chat and chat frequency for each SNS friend on the basis of information regarding a chat made between the SNS friend and the contributor. In this case, by the analysis of the subject of chat, whether many positive chats have been made or whether many negative chats have been made is recognized, for example. The dialog analysis section 164 outputs chat information “f” and information “e” that indicates the frequency of chats made between each of the SNS friends and the contributor and the subjects of the chats.

The determination section 165 calculates the degree-of-closeness value of each SNS friend on the basis of the information outputted from the line-of-sight/posture inference section 163, the information outputted from the dialog analysis section 164, and the information added to the uploaded images, and obtains the degree of closeness which indicates the relationship between the friend and the contributor, by comparing the calculated degree-of-closeness value with a threshold value.

Regarding a certain SNS friend, the degree-of-closeness value of the SNS friend is calculated by expression (1). Here, in a case where the SNS user and the contributor appear together in a plurality of uploaded images, the degree-of-closeness values obtained from the plurality of uploaded images are added to obtain a basic degree-of-closeness value.

Degree-of-closeness value=(basic degree-of-closeness value calculated from uploaded images and chat information)×(increase rate of degree-of-closeness values calculated from information added to images) (1)

A basic degree-of-closeness value that is obtained from uploaded images will be explained. The basic degree-of-closeness value is obtained on the basis of the information outputted from the line-of-sight/posture inference section 163. For example, in a case where the number of persons appearing in an uploaded image is two and where the situation is two shot, the basic degree-of-closeness value is greatly increased. Further, in a case where the line of sight of the SNS friend is pointing toward a camera, the basic degree-of-closeness value is increased. Moreover, in a case where the uploaded image is a group picture in which another person appears in addition to the SNS friend and the contributor, the basic degree-of-closeness value is mildly increased. Further, in a case where the SNS friend smiles or makes a V-sign, the basic degree-of-closeness value is increased.

Next, a basic degree-of-closeness value that is obtained from chat information will be explained. In this case, the basic degree-of-closeness value is calculated on the basis of information outputted from the dialog analysis section 164. In this case, the basic degree-of-closeness value is increased or decreased according to the subject of chat. For example, when the subject of chat is positive, the basic degree-of-closeness value is increased. When the subject of chat is negative, the basic degree-of-closeness value is decreased. In addition, the basic degree-of-closeness value is increased or decreased according to the frequency of chats. For example, when the frequency of chats is greater than a certain threshold value, the basic degree-of-closeness value is increased. When the frequency of chats is less than the certain threshold value, the basic degree-of-closeness value is decreased.

Next, a basic degree-of-closeness value increase rate that is obtained from information added to an image, will be explained. In this case, as the date when an uploaded image was captured is older, the degree-of-closeness value increase rate is corrected downward. In a case where an uploaded image is a selfie, the degree-of-closeness value increase rate is corrected upward.

It is to be noted that whether or not an uploaded image is a selfie can be determined on the basis of not only the information added thereto but also the contents of the uploaded image. For example, in a case where the face of the SNS friend is relatively larger than the faces of people appearing in the uploaded image, the uploaded image can be determined as a selfie. In this case, in case of γ≥2.0 where γ represents the face size ratio, for example, as depicted in FIG. 6, the uploaded image is determined as a selfie. In addition, for example, in a case where the face of the SNS friend is facing a camera and where the line of sight of the SNS friend is pointing toward the camera, the uploaded image can be determined as a selfie.

The determination section 165 obtains the degree-of-closeness value of each SNS friend, which indicates the relationship with the contributor, by comparing the above calculated degree-of-closeness value with a threshold value. In the present embodiment, the degree of closeness is classified into four stages: a close friend, a friend, an estranged friend, and an acquaintance in the descending order. It is to be noted that classification of the degree of closeness is not limited to the above example. In addition, the determination section 165 sets the degree of closeness of a stranger who is not an SNS friend, to a stranger which is the lowest stage. The determination section 165 outputs the degree-of-closeness information “i” regarding SNS users who are the friends and strangers on the SNS.

In such a manner, in a case where the degree-of-closeness information indicates a relationship with the contributor according to the abovementioned classification into a close friend, a friend, an estranged friend, an acquaintance, and a stranger, it is possible for the disclosure permitting/denying determination section 131, which will be explained later, to obtain a result of the determination as to whether the disclosure to the SNS user is permitted or denied, on the basis of whether the relationship with the contributor is a close friend, a friend, an estranged friend, an acquaintance, or a stranger.

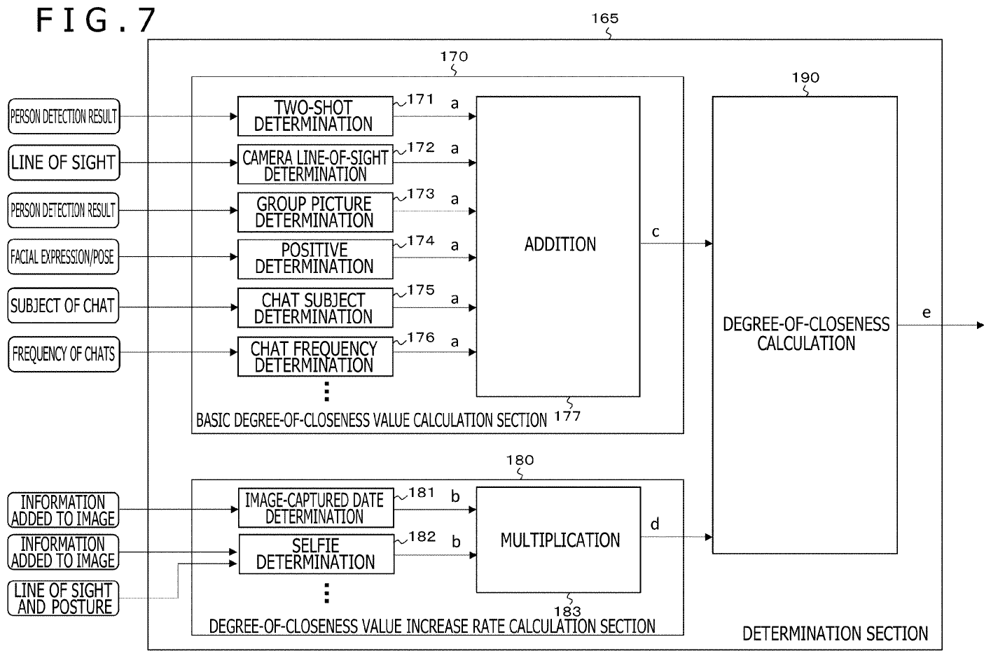

FIG. 7 depicts a configuration example of the determination section 165. The determination section 165 includes a basic degree-of-closeness value calculation section 170, a degree-of-closeness value increase rate calculation section 180, and a degree-of-closeness calculation section 190.

The basic degree-of-closeness value calculation section 170 includes determination sections such as a two-shot determination section 171, a camera line-of-sight determination section 172, a group picture determination section 173, a positive determination section 174, a chat subject determination section 175, and a chat frequency determination section 176, and further includes an addition section 177.

The two-shot determination section 171 makes a two-shot determination on each SNS friend in each image, on the basis of the person detection result, and outputs a basic degree-of-closeness value “a” corresponding to the determination. The camera line-of-sight determination section 172 makes a camera line-of-sight determination on each SNS friend in each image, on the basis of the line-of-sight inference information, and outputs a basic degree-of-closeness value “a” corresponding to the determination.

The group picture determination section 173 makes a group picture determination on each SNS friend in each image, on the basis of the person detection result, and outputs a basic degree-of-closeness value “a” corresponding to the determination. The positive determination section 173 makes a positive determination on each SNS friend in each image, on the basis of the expression/pose inference information, and outputs a basic degree-of-closeness value “a” corresponding to the determination.

The chat subject determination section 175 determines the subject of chat for each SNS friend, on the basis of the chat subject information, and outputs a basic degree-of-closeness value “a” corresponding to the determination. The chat frequency determination section 176 determines the frequency of chats on the basis of the chat frequency information, and outputs a basic degree-of-closeness value “a” corresponding to the determination.

The addition section 177 calculates a basic degree-of-closeness value of each SNS friend by summing the basic degree-of-closeness values “a” of the SNS friend outputted from the respective determination sections. Then, the addition section 177 outputs the basic degree-of-closeness value “c” of each SNS friend.

The degree-of-closeness value increase rate calculation section 180 includes determination sections such as an image-captured date determination section 181 and a selfie determination section 182, and further includes a multiplication section 183.

The image-captured date determination section 181 determines, for each SNS friend, an image-captured date on the basis of the information added to an image, and outputs a degree-of-closeness value increase rate “b” corresponding to a time elapsed from the image-captured date. As the date when an uploaded image was captured is older, the degree-of-closeness value increase rate “b” is corrected downward, as previously explained. The unit of the time elapsed from the image-captured date is not limited to a “day,” and any other time unit such as a “month” or a “year” may be used. That is, information that is included in the information added to the image is not limited to the image-captured date information, and it is sufficient that the information indicates a time elapsed from the image-captured date. Incidentally, although a detailed explanation is omitted, it is also conceivable that the degree-of-closeness value increase rate may be adjusted on the basis of the date difference and the date dispersion in a target image group, for example, in place of the simple comparison with the current date. The selfie determination section 182 determines, for each SNS friend, whether a captured image is a selfie, on the basis of the information added to the image or on the basis of the line-of-sight/posture inference information, and outputs a degree-of-closeness increase rate “b” corresponding to the determination. The multiplication section 183 calculates a degree-of-closeness value increase rate of each SNS friend by multiplying the degree-of-closeness value increase rates “b” of the SNS friend outputted from the respective determination sections. Then, the multiplication section 183 outputs a degree-of-closeness value increase rate “d” of each SNS friend.

The degree-of-closeness calculation section 190 calculates the degree-of-closeness value of each SNS friend according to expression (1) on the basis of the basic degree-of-closeness value “c” of the SNS friend outputted from the addition section 177 and the degree-of-closeness value increase rate “d” of the SNS friend outputted from the multiplication section 183. It is to be noted that, in expression (1), a degree-of-closeness value increase rate is multiplied with an addition value of a basic degree-of-closeness value obtained from an uploaded image and degree-of-closeness information obtained from chat information. However, it is also conceivable that the degree-of-closeness value increase rate may be multiplied with a basic degree-of-closeness value obtained from an uploaded image alone.

The degree-of-closeness calculation section 190 obtains, for each SNS friend, the degree of closeness which indicates the relationship with the contributor, by comparing the above calculated degree-of-closeness value with a threshold value. In this case, the degree of closeness of each SNS friend, which is classified into any one of the four stages: a close friend, a friend, an estranged friend, and an acquaintance in the descending order, is obtained. In addition, the degree-of-closeness calculation section 190 sets the degree of closeness of a stranger who is not an SNS friend, to a stranger which is the lowest stage.

The degree-of-closeness calculation section 190 outputs, as an output of the determination section 165, the degrees of closeness “e” of the friends and strangers on the SNS. Here, the friends and strangers on the SNS are included in the SNS users.

Referring back to FIG. 2, the main process section 103 includes the disclosure permitting/denying determination section 131 and a disclosure image generation section 132. The disclosure permitting/denying determination section 131 receives the input images “a,” the face detection results “b,” and the face-information-eliminated images “e” of the respective detected faces that have undergone the information tagging, which are outputted from the information adding section 123. The disclosure permitting/denying determination section 131 further receives the degree-of-closeness information “i” regarding the SNS users (friends and strangers on the SNS) which is outputted from the degree-of-closeness determination section 106.

According to each of the faces detected by the face detection section 121, that is, depending on whose face is detected by the face detection section 121, the disclosure permitting/denying determination section 131 obtains, for each of the SNS users (i.e., the friends and strangers on the SNS), a result of the determination as to whether the disclosure to the SNS user is permitted or denied, on the basis of information of the degree-of-closeness information “i.” In this case, it is determined, for each of the friends and strangers on the SNS, whether the disclosure to the friend or the stranger is permitted or denied, on the basis of whether the detected face is the face of the contributor, the face of any one of the SNS friends, or the face of a stranger on the SNS.

In this case, a determination criterion is previously defined in the disclosure determination section 131. According to the determination criterion, whether the disclosure is permitted or denied is determined. For example, the contributor can define or change the determination criterion by operating an operation section of the user interface section 104. Here, the determination criterion is used to determine the stage of the degree of closeness of an SNS user to which a face is to be disclosed. The determination criterion may be defined as follows. Specifically, the disclosure range of a face other than the contributor's face may be set such that the face is disclosed to SNS users having the degree of closeness equal to or higher than a predetermined degree, and the disclosure range of the contributor's face may be set such that the contributor's face is disclosed to SNS users having the degree of closeness equal to or higher than a predetermined degree, for example.

The determination result “g” obtained by the disclosure permitting/denying determination section 131 is supplied to the user interface section 104. The user interface section 104 includes a display section and an operation section as interfaces. The determination result “g” is displayed on the display section. As a result, the contributor is allowed to confirm the determination result “g.”

In the user interface section 104, the contributor can operate the operation section to send a command for correcting the determination result, if needed. The correction command “f” is sent from the user interface section 104 to the disclosure permitting/denying determination section 131. The disclosure permitting/denying determination section 131 corrects the determination result according to the correction command “f.” As a result, the contributor can correct the determination result. The disclosure permitting/denying determination section 131 outputs not only a determination result “h” which has been corrected, as appropriate, by the contributor, but also the input images “a” and the face-information-eliminated images “e” to the disclosure image generation section 132.

It is to be noted that, in the above explanation, the disclosure permitting/denying determination section 131 corrects the determination result according to a correction command supplied from the user interface section 104. However, the present embodiment is not limited to the above example. The determination result may be corrected in the user interface section 104 and be sent to the disclosure permitting/denying determination section 131.

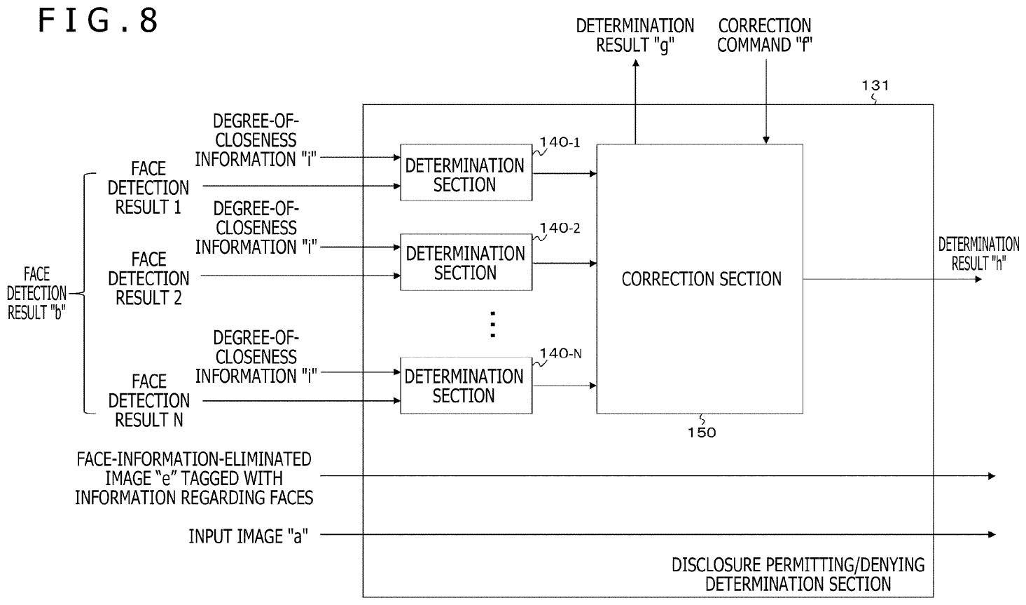

FIG. 8 depicts a configuration example of the disclosure permitting/denying determination section 131. In this example, the number of detected faces is N. The disclosure permitting/denying determination section 131 includes determination sections 140-1 to 140-N and a correction section 150.

For each of the friends and strangers on the SNS, the determination section 140-1 determines whether to permit or deny disclosure of a first face included in the face detection result “b” to the friend or the stranger, on the basis of the degree-of-closeness information “i” regarding the SNS users (the friends and strangers on the SNS) and a face detection result 1 which is a detection result of the first face, according to the determination criterion.

For example, in a case where the first face is the contributor's face and where, in the determination criterion, the disclosure range (view range) of the contributor's face is set such that the contributor's face is disclosed to SNS users having the degree of closeness equal to or higher than the “acquaintance,” the determination section 140-1 determines that the disclosure to SNS users having the degree of closeness equal to or higher than the “acquaintance” is permitted, and that the disclosure to the other SNS users is denied. In addition, for example, in a case where the first face is an SNS friend's face and where, in the determination criterion, the disclosure range (view range) of the SNS friend's face is set such that the SNS friend's face is disclosed to SNS users having the degree of closeness equal to or higher than the “friend,” the determination section 140-1 determines that the disclosure to SNS users having the degree of closeness equal to or higher than the “friend” is permitted, and that the disclosure to the other SNS users is denied.

Although a detailed explanation is omitted, similarly to the determination section 140-1, the respective determination sections 140-2 to 140-N also determine whether to permit or deny disclosure of second to N-th faces included in the face detection result “b” to each of the friends and strangers on the SNS, on the basis of face detection results 2 to N which are detection results of the second to N-th faces, according to the determination criterion.

The correction section 150 receives the determination results obtained by the determination sections 140-1 to 140-N, that is, results of the determination as to whether the disclosure of each of the first to N-th faces to each of the friends and strangers on the SNS is permitted or denied.

The correction section 150 supplies, as the determination results “g,” the determination results obtained by the determination sections 140-1 to 140-N, to the user interface section 104. Further, the correction section 150 receives the correction command “f” sent from the user interface section 104. In a case of receiving the correction command “f,” the correction section 150 corrects the determination results obtained by the determination sections 140-1 to 140-N, according to the correction command.

The correction section 150 outputs the determination results “h.” In a case where the correction command “f” is sent from the user interface section 104, the determination results obtained by the determination sections 140-1 to 140-N are corrected according to the correction command “f,” and the corrected results are used as the determination results “h.” In a case where no correction command “f” is sent from the user interface section 104, the determination results obtained by the determination sections 140-1 to 140-N are used as the determination results “h” without any change.

The disclosure permitting/denying determination section 131 outputs the determination results “h,” and also outputs the input images “a” and the face-information-eliminated images “e” inputted from the information adding section 123, without any change.

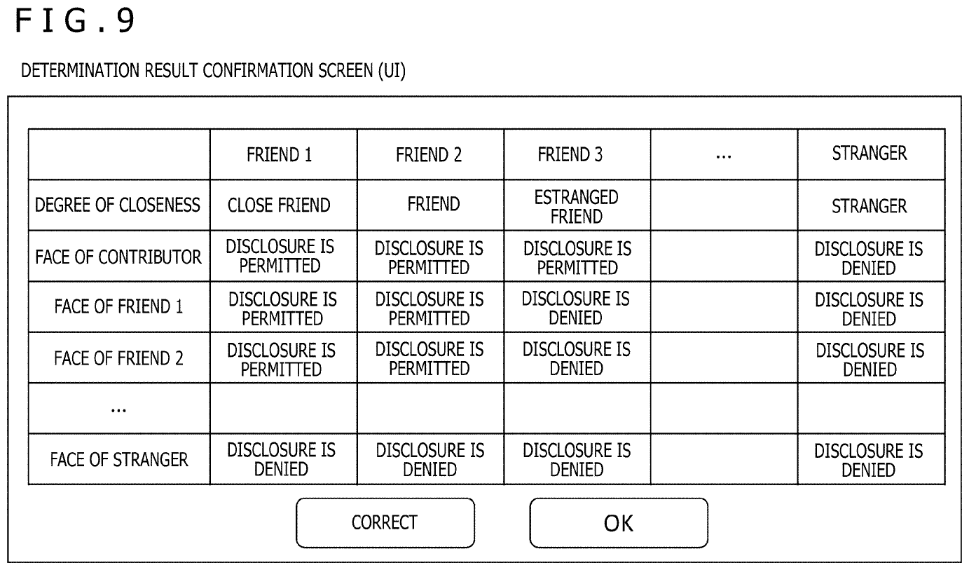

FIG. 9 depicts one example of a determination result confirmation screen which is a user interface screen displayed on the display section of the user interface section 104. The determination result confirmation screen displays the determination results “g” supplied from the disclosure permitting/denying determination section 131 in the abovementioned manner, and allows the contributor to confirm and correct the determination results “g,” if needed. In the depicted example, the friends and a stranger on the SNS (friend 1, friend 2, friend 3, . . . , and stranger) are set on the horizontal axis, while detected faces (face of the contributor, face of the friend 1, face of the friend 2, . . . , and face of the stranger) are set on the vertical axis.

In this case, the degrees of closeness of the friend 1, the friend 2, the friend 3, . . . , and the stranger are a “close friend,” a “friend,” an “estranged friend,” . . . , and a “stranger,” respectively. It is determined that disclosure of the contributor's face to the friend 1, the friend 2, and the friend 3 is permitted, but that the disclosure of the contributor's face to the stranger is denied. In addition, it is determined that disclosure of the faces of the friends 1 and 2 to the friends 1 and 2 is permitted, but that the disclosure of the faces of the friends 1 and 2 to the friend 3 and the stranger is denied. Moreover, it is determined that disclosure of the face of the stranger to all the friend 1, the friend 2, the friend 3, and the stranger is denied.

In a case of accepting the determination result displayed on the determination result confirmation screen, the contributor operates an “OK” button. On the other hand, in a case of correcting the determination result displayed on the determination result confirmation screen, the contributor operates a “correction” button.

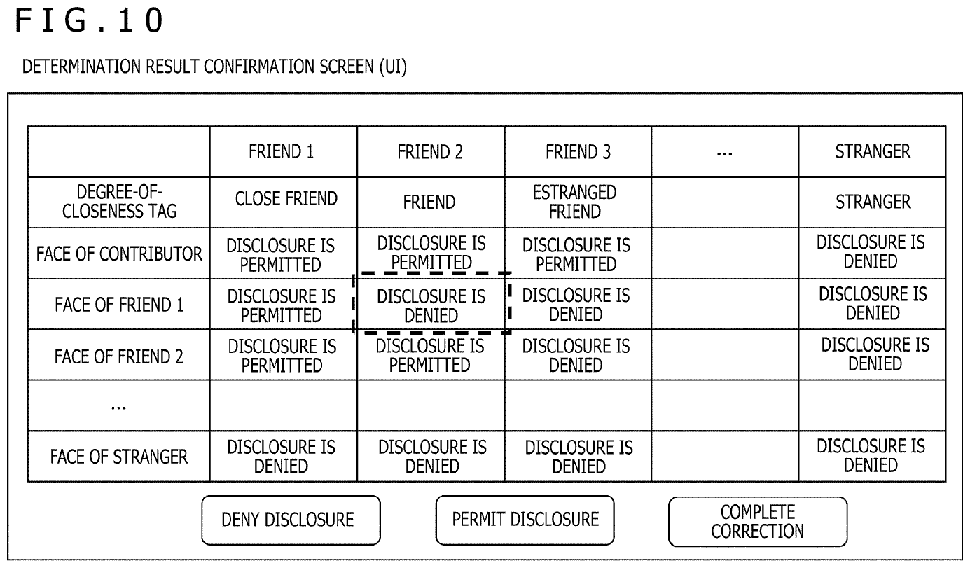

FIG. 10 depicts one example of a determination result correction screen which is a user interface screen displayed in a case where the “correction” button is operated. The contributor designates a part to be corrected, and makes correction on the determination result by operating a “deny disclosure” button or a “permit disclosure” button. In the depicted example, a part indicated by a broken-line frame is designated, and the determination result indicating permission of disclosure of the face of the friend 1 to the friend 2 is corrected to disclosure denial. In a case of completing the correction, the contributor operates a “complete correction” button. As a result, the correction command “f” including the details of the correction is sent from the user interface section 104 to the disclosure permitting/denying determination section 131.

Incidentally, it is also conceivable that the user interface section 104 may send the corrected determination result itself, instead of sending the correction command “f” including the details of the correction to the disclosure permitting/denying determination section 131 in the abovementioned manner.

Referring back to FIG. 2, the image generation section 132 receives the input images “a,” the face-information-eliminated images “e,” and the determination results “h” from the disclosure permitting/denying determination section 131. On the basis of the received data, the image generation section 132 generates disclosure images to be disclosed to the SNS users (the friends and strangers on the SNS). In this case, disclosure images which are as many as the number of the friends on the SNS are generated, and one disclosure image for strangers on the SNS is generated. With such an image generation section 132, it is possible to generate disclosure images to be disclosed to the SNS users and reduce a load on the SNS server 200.

When generating the respective disclosure images for the friends and strangers on the SNS, the image generation section 132 performs a process of eliminating information regarding a face the disclosure of which is denied, from a partial region image that includes the face in the input image “a,” on the basis of positional information regarding the partial region image. For example, this process is achieved by performing mosaic processing, filling the face with a predetermined color, or replacing the face with a predetermined character face. Accordingly, in response to a determination result that indicates prohibition of disclosure of a certain face, it is possible to appropriately generate a disclosure image by performing the process of eliminating information regarding the face from a partial region image that includes the face in the input image “a.”

The image generation section 132 may perform a process of replacing a partial region image with a face-information-eliminated image corresponding to the face, instead of the process of eliminating face information from the partial region image. For example, in a case where the determination result “h” in FIG. 9 is obtained, a disclosure image for the friend 1 is generated by replacing, in the input image “a,” a partial region image that includes a stranger's face with a face-information-eliminated image corresponding to the face. Accordingly, in response to a determination result that indicates prohibition of disclosure of a certain face, it is possible to easily and appropriately generate a disclosure image by performing the process of eliminating information regarding the face from a partial region image that includes the face in the input image a.

The image generation section 132 sends, to the SNS server communication section 105, a disclosure image “j” generated in the abovementioned manner to be disclosed to the SNS users (the friends and strangers on the SNS). The SNS server communication section 105 uploads the disclosure image “j” to the SNS server 200.

The SNS server 200 holds the uploaded disclosure image “j.” In a case where a view request is received from the SNS user 300, the SNS server 200 sends the disclosure image “j” corresponding to the SNS user 300, so that the SNS user 300 can view the disclosure image “j.”

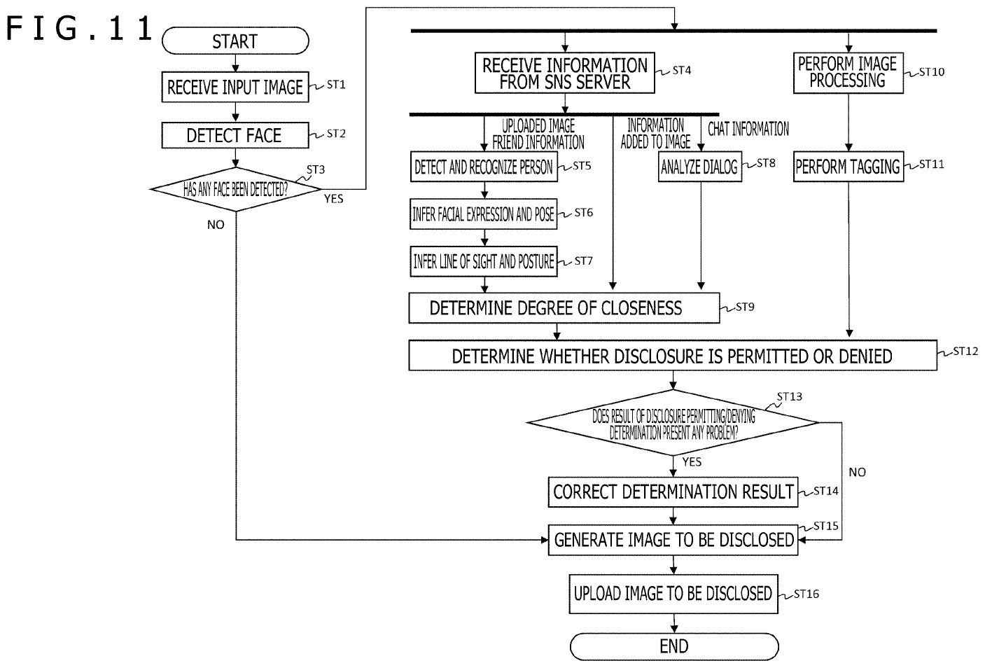

The flowchart in FIG. 11 is one example of the processing procedure performed by the information processing apparatus 100. First, in step ST1, the input reception section 101 of the information processing apparatus 100 receives an input image which is an image to be submitted to the SNS server 200.

Next, in step ST2, the face detection section 121 of the information processing apparatus 100 detects a face included in the input image. Next, in step ST3, the information processing apparatus 100 determines whether or not any face has been detected. In a case where a face has been detected, the information processing apparatus 100 proceeds to a process of determining a degree of closeness or a process of generating a face-information-eliminated image, for example.

In step ST4, the SNS server communication section 105 of the information processing apparatus 100 receives information (e.g., an uploaded image, information added to the uploaded image, chat information) for use in a degree-of-closeness determination, from the SNS server 200.

Next, in step ST5, the person detection/recognition section 161 of the degree-of-closeness determination section 106 of the information processing apparatus 100 detects a person in each of uploaded images on the basis of the uploaded image and the friend information as well as contributor information (which includes face information), and makes individual identification as to whether each of the detected persons is the contributor, any one of the SNS friends, or a third person, i.e., a stranger.

Next, in step ST6, the expression/pose inference section 162 of the degree-of-closeness determination section 106 of the information processing apparatus 100 conducts image analysis for each of the uploaded images in which the contributor and the SNS friends appear together, to infer whether a facial expression or pose of each SNS friend is positive.

Next, in step ST7, the line-of-sight/posture inference section 163 of the degree-of-closeness determination section 106 of the information processing apparatus 100 conducts image analysis for each of the uploaded images in which the contributor and the SNS friends appear together, to infer the line of sight or posture of each SNS friend.

Next, in step ST8, the dialog analysis section 164 of the degree-of-closeness determination section 106 of the information processing apparatus 100 analyzes, for each SNS friend, the subjects of chats made between the SNS friend and the contributor and the frequency of the chats on the basis of information regarding the chats, and obtains information regarding the chat frequency and the subjects of the chats.

Next, in step ST9, the determination section 165 of the degree-of-closeness determination section 106 of the information processing apparatus 100 calculates the degree-of-closeness value of each SNS friend on the basis of the person detection result, the expression/pose inference information, the line-of-sight/posture inference information, the information added to the uploaded image, and the information regarding the chat frequency and the subjects of the chats, for example. Then, the determination section 165 determines the degree of closeness which indicates the relationship with the contributor, by comparing the calculated degree-of-closeness value with a threshold value, and finally obtains information regarding the degrees of closeness of the friends and strangers on the SNS.

Further, in step ST10, the image processing section 122 of the information processing apparatus 100 generates, for each of the detected faces, a face-information-eliminated image that is a partial region image obtained by eliminating face information from an image of the partial region including the detected face. Next, in step ST11, the information adding section 123 of the information processing apparatus 100 tags the face-information-eliminated image of each of the detected faces with positional information, individual identification information, and information indicating that a face image is originally included, and obtains the face-information-eliminated image tagged with information regarding each of the detected faces.

Next, in step ST12, the disclosure permitting/denying determination section 131 of the information processing apparatus 100 obtains a result of the determination as to whether disclosure of each of the detected faces to each of the SNS users, i.e., the friends and strangers on the SNS, is permitted or denied, on the basis of information of the degree-of-closeness information.

Next, in step ST13, the information processing apparatus 100 determines whether the result of the disclosure permitting/denying determination presents any problem. Specifically, whether or not a command for correcting the determination result has been sent is determined. In a case where the determination result presents a problem, the information processing apparatus 100 corrects the determination result in step ST14. Thereafter, the flow proceeds to step ST15. On the other hand, in a case where the determination result presents no problem, the flow proceeds to step ST15 immediately. Also, in a case where any face is not detected in step ST3, the flow proceeds to step ST15 immediately.

In step ST15, the disclosure image generation section 132 of the information processing apparatus 100 generates disclosure images to be disclosed to the SNS users (the friends and strangers on the SNS). Here, in a case where a face is detected in the input image, disclosure images to be disclosed to the SNS users (the friends and strangers on the SNS) are generated on the basis of the input image, the face-information-eliminated image, and the result of the disclosure permitting/denying determination. In this case, respective disclosure images for the friends and strangers on the SNS are generated by replacing, in the input image, a partial region image including the face disclosure of which is denied, with a face-information-eliminated image corresponding to the face. On the other hand, in a case where no face is detected in the input image, the input image is used as a disclosure image to be disclosed to the SNS users (the friends and strangers on the SNS), without any change.

Next, in step ST16, the SNS server communication section 105 of the information processing apparatus 100 uploads the disclosure image to the SNS server 200. It is to be noted that, in the flowchart in FIG. 11, each time an input image which is an image to be submitted is received, the degree of closeness of each of the SNS users (the friends and strangers on the SNS) is determined, and the determination result is used. However, after the determination on the degree of closeness is made, the determination result can repeatedly be used for a certain period of time. That is, it is not necessary to determine the degree of closeness of each of the SNS users (the friends and strangers on the SNS) each time an input image which is an image to be submitted is received.

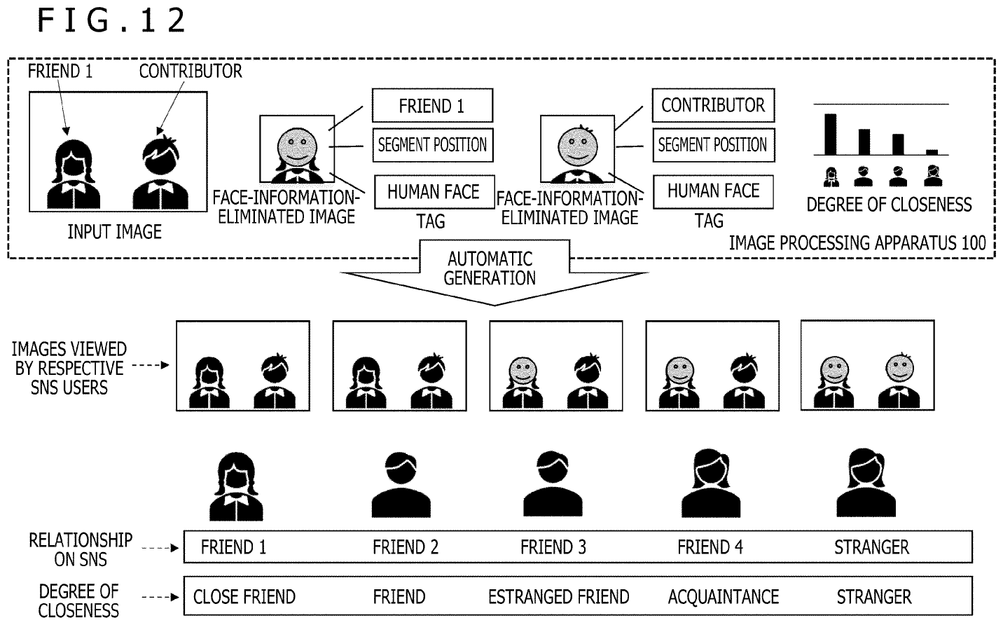

FIG. 12 depicts one example of an image (disclosure image) that is automatically generated by the information processing apparatus 100 and that is viewed by SNS users (the friends and strangers on the SNS). In the depicted example, an input image includes the face of the contributor and the face of the friend 1. In this case, the information processing apparatus 100 detects the face of the contributor and the face of the friend 1 in the input image, and generates face-information-eliminated images corresponding to these faces.

Further, in this case, the information processing apparatus 100 determines the degrees of closeness of the SNS users (the friends and strangers on the SNS). The degrees of closeness of the friend 1, the friend 2, the friend 3, and a friend 4, who are friends on the SNS, are determined to be a “close friend,” a “friend,” an “estranged friend,” and an “acquaintance,” respectively, on the basis of the friend information. In addition, the degree of closeness of a stranger on the SNS is set to the “stranger” which is the lowest stage.

Then, on the basis of the degree-of-closeness information regarding the SNS users (the friends and strangers on the SNS), the information processing apparatus 100 determines whether disclosure of the face of the contributor and the face of the friend 1 to each of the friends and strangers on the SNS is permitted or denied, according to the determination criterion. FIG. 12 depicts an example in which, in the determination criterion, the disclosure range (view range) of the face of the contributor is set such that the face is disclosed to SNS users having the degree of closeness equal to or higher than the “acquaintance,” and the disclosure range (view range) of the face of anyone other than the contributor is set such that the face is disclosed to SNS users having the degree of closeness equal to or higher than the “friend.”

On the basis of the result of the determination as to whether the disclosure of the face of the contributor and the face of the friend 1 to each of the friends and strangers on the SNS is permitted or denied, the information processing apparatus 100 generates disclosure images (view images) for the respective SNS users who are the friends and strangers on the SNS. In this case, in the disclosure images for the friends 1 and 2, both the face of the contributor and the face of the friend 1 are disclosed. In addition, in the disclosure images for the friends 3 and 4, the face of the contributor is disclosed, but the face of the friend 1 is not disclosed. Moreover, in the disclosure image for strangers, neither the face of the contributor nor the face of the friend 1 is disclosed.

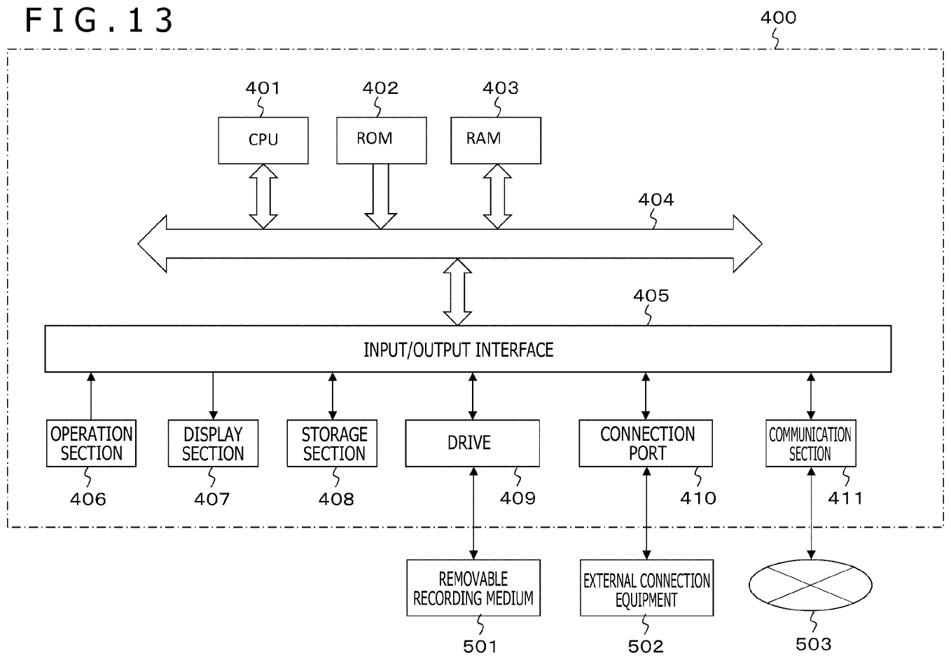

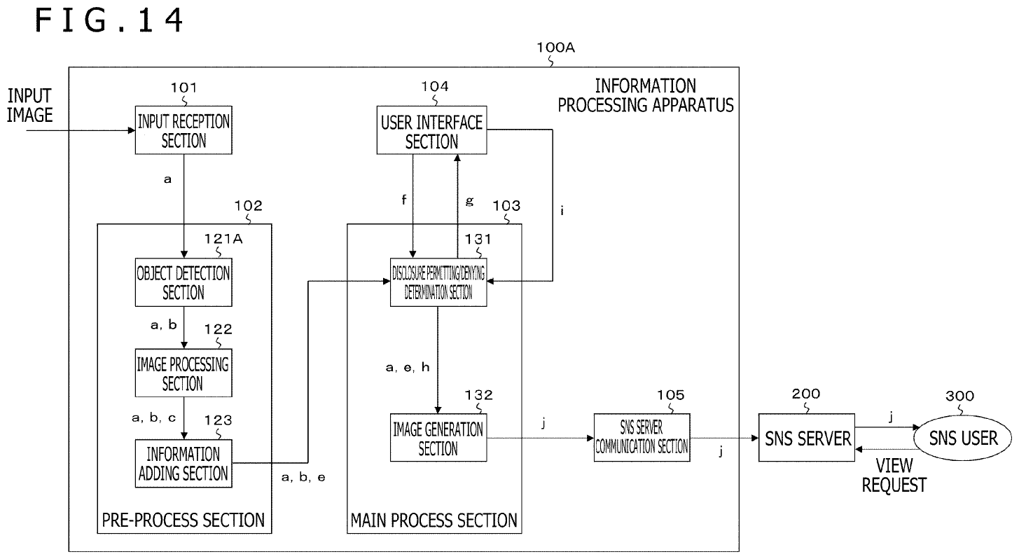

FIG. 13 depicts a configuration example of a PC (personal computer) 400 constituting the information processing apparatus 100. The PC 400 includes a CPU 401, a ROM 402, a RAM 403, a bus 404, an input/output interface 405, an operation section 406, a display section 407, a storage section 408, a drive 409, a connection port 410, and a communication section 411. It is to be noted that the depicted configuration is one example. Some of the constituent elements may be omitted. In addition, a constituent element other than the depicted constituent elements may further be included.

The CPU 401 functions as a computation processor or a controller, for example. The CPU 401 controls the general operation or a partial operation of the constituent elements on the basis of any of various programs recorded in the ROM 402, the RAM 403, the storage section 408, or a removable recording medium 501.

The ROM 402 is means for storing a program to be read by the CPU 401 and data, etc., to be used for computation. For example, a program to be read by the CPU 401 and various parameters that appropriately vary when the program is executed are temporarily or permanently stored in the RAM 403.

The CPU 401, the ROM 402, and the RAM 403 are mutually connected via the bus 404. Further, various constituent elements are connected to the bus 404 via the input/output interface 405.

The operation section 406 receives operation input from a user and outputs an operation signal corresponding to the received operation input, to the CPU 401. For example, a mouse, a keyboard, a touch panel, a button, a switch, a lever, or the like is used as the operation section 406. Alternatively, a remote controller (hereinafter, referred to as a “remote”) capable of transmitting a control signal by using infrared rays or any radio waves may be used as the operation section 406.

The display section 407 includes a liquid crystal display or an organic EL display. Under the control of the CPU 401, the display section 407 displays various types of information. Here, the operation section 406 and the display section 407 constitute a user interface.

The storage section 408 is a device for storing various types of data. For example, a magnetic storage device such as a hard disk drive (HDD), a semiconductor device, an optical storage device, a magneto-optical storage device, or the like is used as the storage section 408.

The drive 409 is a device for reading out information recorded in the removable recording medium 501 which is a magnetic disk, an optical disk, a magneto-optical disk, a semiconductor memory, or the like, or writing information into the removable recording medium 501.

The removable recording medium 501 is a DVD medium, a Blu-ray (registered trademark) medium, an HD DVD medium, or any of various semiconductor storage media, for example. Needless to say, the removable recording medium 501 may be an IC card with a non-contact type IC chip mounted thereon or an electronic device, for example.

The connection port 410 is a port for connection with the external connection equipment 502. For example, the connection port 410 is a USB (Universal Serial Bus) port, an IEEE1394 port, an HDMI (High-Definition Multimedia Interface) port, an SCSI (Small Computer System Interface) port, an RS-232C port, or an optical audio terminal. The external connection equipment 502 is a printer, a mobile music player, a digital camera, a digital video camera, or an IC recorder, for example.

The communication section 411 is a communication device for establishing connection with a network 503. For example, the communication section 411 is a wired or wireless LAN, a Bluetooth (registered trademark), a WUSB (Wireless USB) communication card, an optical communication router, an ADSL (Asymmetric Digital Subscriber Line) router, a modem for different types of communications, or the like.

As described so far, the disclosure permitting/denying determination section 131 of the information processing apparatus 100 of the image disclosing system 10, which is depicted in FIG. 1, obtains a result of determination as to whether disclosure of a face that is a determination target object included in an image to be submitted to the SNS server 200, to the SNS user 300 is permitted or denied, on the basis of the degree-of-closeness information “i” which indicates the relationship between the SNS user 300 and the contributor. Accordingly, an image that is generated according to the degree of closeness indicating the relationship with the contributor can be disclosed to the SNS user 300, and the image can be disclosed to many SNS users 300 while the privacy protection is achieved in the image disclosed to the SNS users 300. Thus, the convenience is enhanced.

### 2. Modification

It is to be noted that the information processing apparatus 100 according to the abovementioned embodiment detects faces included in an image to be submitted to the SNS server 200, and the disclosure permitting/denying determination section 131 obtains a result of determination as to whether disclosure of each of the detected faces to each of SNS users who are the friends and strangers on the SNS is permitted or denied, on the basis of the degree-of-closeness information “i.”

However, the determination target object that is detected in an image to be submitted to the SNS server is not limited to the face and may be any preset object. Besides human faces, examples of such a preset object include any other object (e.g., automobile license plate) related to privacy protection and an object that is required by the contributor.

Moreover, in the information processing apparatus 100 according to the abovementioned embodiment, the degree-of-closeness determination section 106 calculates the degree-of-closeness value of each of the friends on the SNS on the basis of information obtained from the SNS server 200, and obtains the degree of closeness which indicates the relationship between the friend and the contributor, by comparing the calculated degree-of-closeness value with a threshold value. Then, the degree-of-closeness determination section 106 supplies the degree-of-closeness information “i” regarding the SNS users (the friends and strangers on the SNS) to the disclosure permitting/denying determination section 131.

However, it is also conceivable that the degree-of-closeness information “i” regarding the SNS users (the friends and strangers on the SNS) may be supplied from the user interface section 104 to the disclosure permitting/denying determination section 131. In this case, it is not necessary to calculate the degree-of-closeness value of each of the friends on the SNS on the basis of information obtained from the SNS server 200, and the contributor can define the degrees of closeness of SNS users including the friends on the SNS, as desired. Accordingly, it is possible to obtain a result of determination as to whether disclosure to an SNS user is permitted or denied, on the basis of the degree-of-closeness information which is defined by the contributor and which indicates the relationship between the SNS user and the contributor.

FIG. 14 depicts a configuration example of another information processing apparatus 100A while taking the above case into consideration. In FIG. 14, a section corresponding to that in FIG. 2 is denoted by the same reference sign, and a detailed explanation thereof will be omitted. In the information processing apparatus 100A, the pre-process section 102 includes an object detection section 121A in place of the face detection section 102 in FIG. 2. The object detection section 121A detects any preset object. In addition, in the information processing apparatus 100A, the degree-of-closeness information “i” regarding the SNS users (the friends and strangers on the SNS) is supplied from the user interface section 104 to the disclosure permitting/denying determination section 131. Accordingly, the disclosure permitting/denying determination section 131 obtains a result of determination as to whether disclosure of each object detected by the object detection section 121A to each of SNS users who are the friends and strangers on the SNS is permitted or denied, on the basis of the degree-of-closeness information “i.”

The other constituent elements of the information processing apparatus 100A are similar to those of the information processing apparatus 100 depicted in FIG. 2 and the operation thereof is also similar to that of the information processing apparatus 100. Thus, an explanation thereof will be omitted.

Moreover, in the information processing apparatus 100 according to the abovementioned embodiment, the image generation section 132 generates disclosure images to be disclosed to SNS users (the friends and strangers on the SNS), on the basis of the input image “a,” the face-information-eliminated image “e,” and the determination result “h,” and the disclosure images are uploaded to the SNS server 200 via the SNS server communication section 105. However, it is also conceivable that disclosure images to be disclosed to SNS users (the friends and strangers on the SNS) may be generated by the SNS server 200.

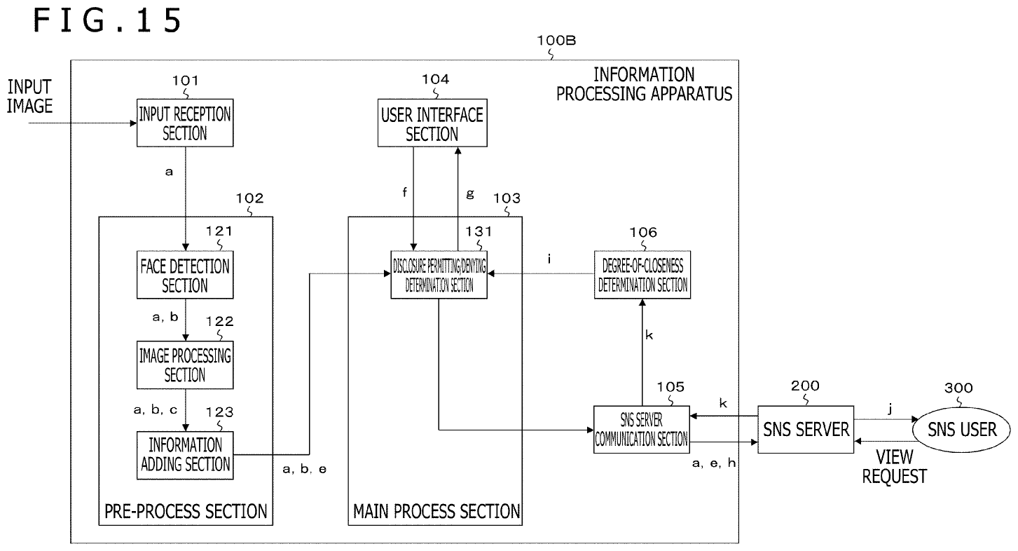

FIG. 15 depicts a configuration example of another information processing apparatus 100B while taking the above case into consideration. In FIG. 15, a section corresponding to that in FIG. 2 is denoted by the same reference sign, and a detailed explanation thereof will be omitted. In the information processing apparatus 100B, the main process section 103 does not include the image generation section 132 depicted in FIG. 2. The input image “a,” the face-information-eliminated image “e,” and the determination result “h” outputted from the disclosure permitting/denying determination section 131 are uploaded to the SNS server 200 via the SNS server communication section 105. The SNS server 200 generates disclosure images to be disclosed to the SNS users (the friends and strangers on the SNS), on the basis of the input image “a,” the face-information-eliminated image “e,” and the determination result “h,” as in the image generation section 132 in FIG. 2.

The other constituent elements of the information processing apparatus 100B are similar to those of the information processing apparatus 100 depicted in FIG. 2, and the operation thereof is also similar to that of the information processing apparatus 100. Thus, an explanation thereof will be omitted.

In the example of the abovementioned embodiment, the image submission server is an SNS server. However, the server is not limited to SNS servers.

The preferable embodiment of the present disclosure has been explained in detail with reference to the drawings. However, the technical scope of the present disclosure is not limited to the embodiment. It is clear that a person who has an ordinary skill in the art can conceive of various modifications and revisions within the scope of the technical concept set forth in the claims. These modifications and revisions are also considered to be obviously within the technical scope of the present disclosure.

The effects described in the present description are illustrative or exemplary ones, and effects are not limited to them. That is, the technology according to the present disclosure can provide any other effect that is obvious to a person skilled in the art from the present description, in addition to or in place of the abovementioned effects.

Further, the present technology can also take the following configurations.

(1)

An information processing apparatus including:
a disclosure permitting/denying determination section that obtains, on the basis of degree-of-closeness information indicating a relationship between a user and a contributor, a result of determination as to whether disclosure of a determination target object to the user is permitted or denied, the determination target object being included in an image to be submitted to an image submission server.
   (2)

The information processing apparatus according to (1) described above, in which
the relationship between the user and the contributor is set to a friend on the image submission server.
   (3)

The information processing apparatus according to (1) or (2) described above, in which
the disclosure permitting/denying determination section supplies the determination result to a user interface section so as to allow the contributor to confirm the determination result.
   (4)

The information processing apparatus according to (3) described above, in which
the disclosure permitting/denying determination section corrects the determination result according to a correction command supplied from the user interface section.
   (5)

The information processing apparatus according to any one of (1) to (4) described above, in which
the determination target object includes an object related to privacy protection.
   (6)

The information processing apparatus according to (5) described above, in which
the determination target object includes a human face.
   (7)

The information processing apparatus according to (6) described above, in which
the disclosure permitting/denying determination section determines whether the disclosure is permitted or denied, depending on whose face is the determination target object.
   (8)

The information processing apparatus according to any one of (1) to (7) described above, in which
the degree-of-closeness information indicates the relationship between the user and the contributor that is classified as any one of a close friend, a friend, an estranged friend, an acquaintance, and a stranger.
   (9)

The information processing apparatus according to any one of (1) to (8) described above, further including:
an object detection section that detects the determination target object included in the image to be submitted to the image submission server.
   (10)

The information processing apparatus according to (9) described above, in which
in a case where the determination target object is a human face, the object detection section further detects whose face has been detected.
   (11)

The information processing apparatus according to any one of (1) to (10) described above, in which
the disclosure permitting/denying determination section obtains, from a user interface section being operated by the contributor, the degree-of-closeness information indicating the relationship between the user and the contributor.
   (12)

The information processing apparatus according to any one of (1) to (11) described above, further including:
a degree-of-closeness determination section that obtains the degree-of-closeness information indicating the relationship between the user and the contributor, on the basis of information obtained from the image submission server.
   (13)

The information processing apparatus according to (12) described above, in which
the degree-of-closeness determination section obtains the degree-of-closeness information by calculating a degree-of-closeness value of the user on the basis of the information obtained from the image submission server, and comparing the calculated degree-of-closeness value with a threshold value.
   (14)

The information processing apparatus according to (13) described above, in which
the information obtained from the image submission server includes at least either an uploaded image or chat information.
   (15)

The information processing apparatus according to (14) described above, in which
information added to the uploaded image includes at least either information indicating a time elapsed from capturing of the uploaded image or information regarding whether the uploaded image is a selfie.
   (16)

The information processing apparatus according to any one of (1) to (16) described above, further including:
an image generation section that generates a disclosure image to be disclosed to the user, on the basis of the result of the determination as to whether the disclosure is permitted or denied, by use of the image to be submitted to the image submission server and information regarding the determination target object.
   (17)

The information processing apparatus according to (16) described above, in which
the information regarding the determination target object includes at least positional information regarding an image of a partial region that includes the determination target object in the image to be submitted to the image submission server.
   (18)

The information processing apparatus according to (17) described above, in which
the information regarding the determination target object further includes an image of the partial region from which information regarding the determination target object has been eliminated.
   (19)

An information processing method including:
a disclosure permitting/denying determination process of obtaining, on the basis of degree-of-closeness information indicating a relationship between a user and a contributor, a result of determination as to whether disclosure of a determination target object to the user is permitted or denied, the determination target object being included in an image to be submitted to an image submission server.
   (20)

A program for causing a computer to function as:
a disclosure permitting/denying determination section that obtains, on the basis of degree-of-closeness information indicating a relationship between a user and a contributor, a result of determination as to whether disclosure of a determination target object to the user is permitted or denied, the determination target object being included in an image to be submitted to an image submission server.

### REFERENCE SIGNS LIST

10: Image disclosing system
100, 100A, 100B: Information processing apparatus
101: Input reception section
102: Pre-process section
121: Face detection section
121A: Object detection section
122: Image processing section
123: Information adding section
103: Main process section
131: Disclosure permitting/denying determination section
140-1 to 140-N: Determination section
150: Correction section
132: Image generation section
104: User interface section
105: SNS server communication section
106: Degree-of-closeness determination section
161: Person detection/recognition section
162: Expression/pose inference section
163: Line-of-sight/posture inference section
164: Dialog analysis section
165: Determination section
170: Basic degree-of-closeness value calculation section
171: Two-shot determination section
172: Camera line-of-sight determination section
173: Group picture determination section
174: Positive determination section
175: Chat subject determination section
176: Chat frequency determination section
177: Addition section
180: Degree-of-closeness value increase rate calculation section 181: Image-captured date determination section
182: Selfie determination section
183: Multiplication section
190: Degree-of-closeness calculation section
200: SNS server
300: SNS user
400: Personal computer

1. An information processing apparatus comprising:
a disclosure permitting/denying determination section that obtains, on a basis of degree-of-closeness information indicating a relationship between a user and a contributor, a result of determination as to whether disclosure of a determination target object to the user is permitted or denied, the determination target object being included in an image to be submitted to an image submission server.

2. The information processing apparatus according to claim 1, wherein
the relationship between the user and the contributor is set to a friend on the image submission server.

3. The information processing apparatus according to claim 1, wherein
the disclosure permitting/denying determination section supplies the determination result to a user interface section so as to allow the contributor to confirm the determination result.

4. The information processing apparatus according to claim 3, wherein
the disclosure permitting/denying determination section corrects the determination result according to a correction command supplied from the user interface section.

5. The information processing apparatus according to claim 1, wherein
the determination target object includes an object related to privacy protection.

6. The information processing apparatus according to claim 5, wherein
the determination target object includes a human face.

7. The information processing apparatus according to claim 6, wherein
the disclosure permitting/denying determination section determines whether the disclosure is permitted or denied, depending on whose face is the determination target object.

8. The information processing apparatus according to claim 1, wherein
the degree-of-closeness information indicates the relationship between the user and the contributor that is classified as any one of a close friend, a friend, an estranged friend, an acquaintance, and a stranger.

9. The information processing apparatus according to claim 1, further comprising:
an object detection section that detects the determination target object included in the image to be submitted to the image submission server.

10. The information processing apparatus according to claim 9, wherein
in a case where the determination target object is a human face, the object detection section further detects whose face has been detected.

11. The information processing apparatus according to claim 1, wherein
the disclosure permitting/denying determination section obtains, from a user interface section being operated by the contributor, the degree-of-closeness information indicating the relationship between the user and the contributor.

12. The information processing apparatus according to claim 1, further comprising:
a degree-of-closeness determination section that obtains the degree-of-closeness information indicating the relationship between the user and the contributor, on a basis of information obtained from the image submission server.

13. The information processing apparatus according to claim 12, wherein
the degree-of-closeness determination section obtains the degree-of-closeness information by calculating a degree-of-closeness value of the user on the basis of the information obtained from the image submission server, and comparing the calculated degree-of-closeness value with a threshold value.

14. The information processing apparatus according to claim 13, wherein
the information obtained from the image submission server includes at least either an uploaded image or chat information.

15. The information processing apparatus according to claim 14, wherein
information added to the uploaded image includes at least either information indicating a time elapsed from capturing of the uploaded image or information regarding whether the uploaded image is a selfie.

16. The information processing apparatus according to claim 1, further comprising:
an image generation section that generates a disclosure image to be disclosed to the user, on a basis of the result of the determination as to whether the disclosure is permitted or denied, by use of the image to be submitted to the image submission server and information regarding the determination target object.

17. The information processing apparatus according to claim 16, wherein
the information regarding the determination target object includes at least positional information regarding an image of a partial region that includes the determination target object in the image to be submitted to the image submission server.

18. The information processing apparatus according to claim 17, wherein
the information regarding the determination target object further includes an image of the partial region from which information regarding the determination target object has been eliminated.

19. An information processing method comprising:
a disclosure permitting/denying determination process of obtaining, on a basis of degree-of-closeness information indicating a relationship between a user and a contributor, a result of determination as to whether disclosure of a determination target object to the user is permitted or denied, the determination target object being included in an image to be submitted to an image submission server.

20. A program for causing a computer to function as:
a disclosure permitting/denying determination section that obtains, on a basis of degree-of-closeness information indicating a relationship between a user and a contributor, a result of determination as to whether disclosure of a determination target object to the user is permitted or denied, the determination target object being included in an image to be submitted to an image submission server.
